(19) United States
(12) Patent Application Publication
(10) Pub. No.: US 2008/0129690 A1
(43) Pub. Date: Jun. 5, 2008

(54) Pointing stick structure for input device

(75) Inventor: Chih-Nan Lin, Huwei Township (TW)

Correspondence Address: REED SMITH LLP, 3110 FAIRVIEW PARK DRIVE, SUITE 1400, FALLS CHURCH, VA, 22042, US

(73) Assignee: Darfon Electronics Corporation

(21) Appl. No.: 11/987,850

(22) Filed: Dec. 5, 2007

(30) Foreign Application Priority Data
Dec. 5, 2006 (TW) 95221381

(51) Int. Cl. G09G 5/00

(52) U.S. Cl. 345/156

(57) ABSTRACT

A pointing-stick structure for input device includes: a print circuit board, a light-emitting device, a stick, and a cap. The light-emitting device electrically connects to the print circuit board. The stick receives the light-emitting device and is connected the print circuit board, and the cap covers the top of the stick. The light emitted from the light-emitting device projects through the cap.

### CROSS REFERENCE TO RELATED APPLICATIONS

This application claims the right of priority based on Taiwan Patent Application No. 095221381, entitled “Pointing Stick Structure for Input Device”, filed on Dec. 5, 2006, which is incorporated herein by reference and assigned to the assignee herein.

### FIELD OF INVENTION

The present invention generally relates to a pointing-stick structure for an input device, and more particularly, to a light emitting pointing-stick structure for an input device.

### BACKGROUND OF THE INVENTION

Laptop computers have been more and more popular. Compared with the desktop computers, new and special designs for laptops are mushrooming. For example, an input device for a laptop may include a tough panel, a pointing stick, and so on. The pointing stick not only has functions like a mouse, but also has an advantage of reduced size, which is able to be disposed between the keys on the keyboard.

Generally, the pointing stick is disposed between the keys on the central area of the keyboard. However, if in the dark place, the pointing stick may be too small to be found by the users.

In order to make users easier to find the pointing stick on the keyboard in the dark, a light emitting pointing-stick structure for an input device is desired.

### SUMMARY OF THE INVENTION

One aspect of the present invention is to provide a light emitting pointing-stick structure for an input device so that a user, in the dark, is able to operate the device with the help of the light emitting pointing stick. Another aspect of the present invention is to provide a new structure and appearance for the input device.

In one embodiment, the present invention provides a pointing-stick structure for an input device including: a circuit board, a light-emitting device, a stick, and a cap. The light-emitting device is electrically connected to the circuit board and received in the stick. The stick is connected to the circuit board. And the cap covers the top of the stick. The light emitted from the light-emitting device is capable of projecting through the cap.

In another embodiment, the present invention provides a pointing-stick structure for an input device including: a circuit board and a stick. The circuit board includes a light-emitting device. The stick covers the top of the stick and is connected to the circuit board. The light emitted from the light-emitting device is capable of projecting through the stick.

In yet another embodiment, the present invention provides a pointing-stick structure for an input device including: a circuit board, a stick, and a light-converging unit. The circuit board includes a light-emitting device. The stick provides an opening corresponding to the light-emitting device and is connected to the circuit board. The light-converging unit is disposed on the stick for converging the light emitted from the light-emitting device.

The foregoing and other features of the invention will be apparent from the following more particular description of embodiment of the invention.

### BRIEF DESCRIPTION OF THE DRAWINGS

FIG. 1 is a schematic illustration in accordance with a first embodiment of the present invention.

FIGS. 2 is a schematic illustration in accordance with a second embodiment of the present invention.

FIG. 3 is a schematic illustration in accordance with a third embodiment of the present invention.

FIG. 4 is a schematic illustration illustrating applied examples in accordance with all embodiments of the present invention.

### DETAILED DESCRIPTION OF THE INVENTION

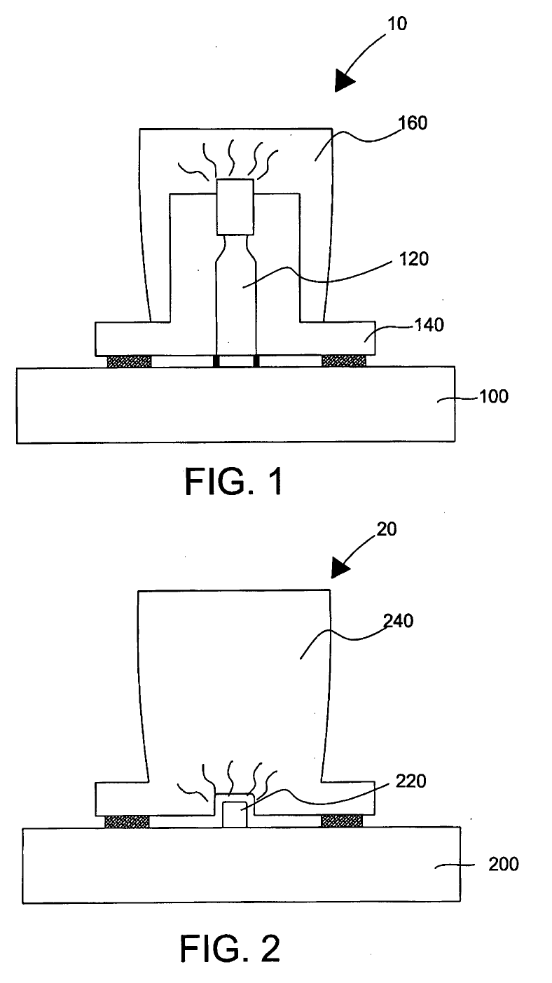

The present invention discloses a pointing-stick structure for a light emitting input device. The following description is stated with reference to the accompanying drawings from FIG. 1 to FIG. 3.

FIG. 1 illustrates the first embodiment of the present invention. As shown in FIG. 1, the light emitting pointing-stick structure 10 for the input device includes a circuit board 100, a light-emitting device 120, a stick 140, and a cap 160. The light-emitting device 120, such as a light emitting diode, is electrically connected to the circuit board 100 for supplying the power to the light-emitting device 120. The light-emitting device 120 is received in the stick 140. The stick 140 is connected to the circuit board 100, wherein the stick 140 is made of ceramic material. Preferably the cap 160 covers the top of the stick 140. Therefore, the light emitted from the light-emitting device 120 is capable of projecting through the cap 16O. Preferably, the cap 160 is made of transparent material such as acrylic material, and the like.

FIG. 2 illustrates the second embodiment of the present invention. As shown in FIG. 2, the light emitting pointing-stick structure 20 for the input device includes a stick 240 and a circuit board 200 having a light-emitting device 220. In the second embodiment, the light-emitting device 220, such as a light emitting diode, is integrated into the circuit board 200. Connected to the circuit board 200, the stick 240 covers the light-emitting device 220, wherein the light emitted from the light-emitting device 220 is projected through the stick 240. To be pushed or pulled daily by user, the stick 240 is preferably made of hard and transparent material such as acrylic, plastic, and so forth.

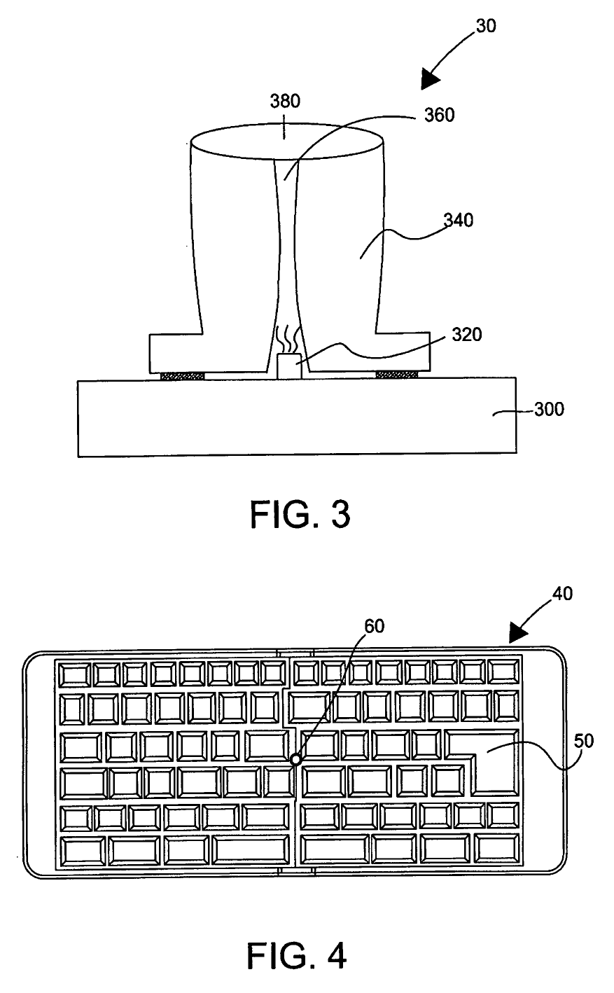

FIG. 3 illustrates the third embodiment of the present invention. As shown in FIG. 3, the light emitting pointing-stick structure 30 for the input device includes a stick 340, a light-converging unit 380, and a circuit board 300 having a light-emitting device 320. In the third embodiment, the light-emitting device 320, such as a light emitting diode, is integrated into the circuit board 300. The stick 340 is made of opaque material such as ceramic, and the like. Moreover, the stick 340 is connected to the circuit board 300 and provides an opening 360 corresponding to the light-emitting device 320, so as to allow the light emitted from the light-emitting device 320 to pass through the opening 360. Then the light-converging unit 380 is disposed on top of the stick 340 for converging the light through the opening 360.

FIG. 4 illustrates the light emitting pointing-stick structure for the input device in accordance with the first, second, and third embodiments of the present invention. The light emitting pointing-stick structures 10, 20, 30 for the input device are disposed on the area between keys 50 on the keyboard 40 as the position of the point stick 60 shown in FIG. 4. Therefore, the light emitted from the pointing stick 60 helps a user operate the input device with light emitting pointing stick in the dark place and also increases variations of the appearance.

Although the present invention has been explained in relation to its preferred embodiment, it is to be understood that many other possible modifications and variations can be made without departing from the scope of the invention as hereinafter claimed.

What is claimed is:

1. A pointing-stick structure for an input device, comprising:
a circuit board;
a light-emitting device electrically connected to said circuit board;
a stick, connected to said circuit board, for receiving said light-emitting device; and
a cap covering the top of said stick;
wherein the light emitted from said light-emitting device is projected through said cap.

2. The pointing-stick structure of claim 1, wherein said light-emitting device is a light emitting diode.

3. The pointing-stick structure of claim 1, wherein said stick is made of ceramic material.

4. The pointing-stick structure of claim 1, wherein said cap is light-transmissive.

5. The pointing-stick structure of claim 1, wherein said cap is made of acrylic material.

6. A pointing-stick structure for an input device, comprising:
a circuit board, wherein said circuit board comprises a light-emitting device; and
a stick, connected to said circuit board, for covering said light-emitting device;
wherein the light emitted from said light-emitting device is projected through said stick.

7. The pointing-stick structure of claim 6, wherein said light-emitting device is a light emitting diode.

8. The pointing-stick structure of claim 6, wherein said stick is light-transmissive.

9. The pointing-stick structure of claim 6, wherein said stick is made of hard acrylic material or hard plastic material.

10. A pointing-stick structure for an input device, comprising:
a circuit board, wherein said circuit board comprises a light-emitting device;
a stick, connected to said circuit board, for providing an opening corresponding to said light-emitting device; and
a light-converging unit disposed on said stick for converging the light emitted from said light-emitting device.

11. The pointing-stick structure of claim 10, wherein said light-emitting device is a light emitting diode.

12. The pointing-stick structure of claim 10, wherein said stick is made of ceramic material.
